(19) United States
(12) Patent Application Publication
(10) Pub. No.: US 2020/0062977 A1
(43) Pub. Date: Feb. 27, 2020

(54) WRITING, MARKING, AND/OR DRAWING LIQUID FOR CAPILLARY SYSTEMS, ESPECIALLY FOR APPLICATOR IMPLEMENTS HAVING A CAPILLARY SYSTEM, AND APPLICATOR IMPLEMENT

(71) Applicant: FABER-CASTELL AG, Stein (DE)

(72) Inventors: WOLFGANG SCHWARZ, SACHSEN BEI ANSBACH (DE); GERHARD LUGERT, NUERNBERG (DE); CONCETTA GOSCHALA, NUERNBERG (DE)

(21) Appl. No.: 16/548,098

(22) Filed: Aug. 22, 2019

(30) Foreign Application Priority Data
Aug. 22, 2018 (EP) 18190272.7

(51) Int. Cl. C09D 11/17; B43K 8/03; B43K 8/06

(52) U.S. Cl. CPC C09D 11/17; B43K 8/06; B43K 8/03

(57) ABSTRACT

A writing, marking and/or drawing liquid, more particularly an aqueous, pigmented and/or water-blendable writing, marking and/or drawing liquid, is provided for capillary systems, more particularly for applicator implements having a capillary system. The liquid has a viscosity of less than 40 mPas, more particularly less than 10 mPas (Brookfield, 20° C., cone-plate CPE-40) and includes an aqueous pigment preparation, a binder, a base, and a dispersing wetting agent. The dispersing wetting agent includes an aqueous solution of a modified polymer having groups with pigment affinity. An applicator implement in which a writing, marking or drawing liquid of this kind is used is also provided.

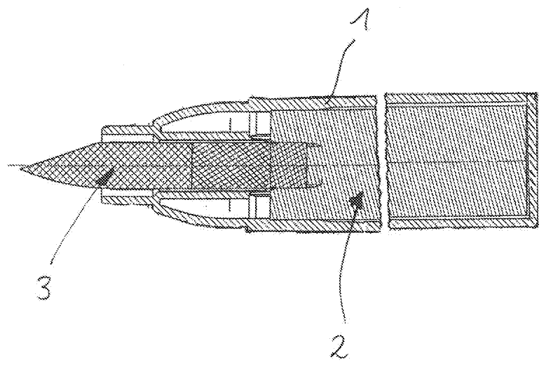

### CROSS-REFERENCE TO RELATED APPLICATION

This application claims the priority, under 35 U.S.C. § 119, of European Patent Application EP 18 190 272.7, filed Aug. 22, 2018; the prior application is herewith incorporated by reference in its entirety.

### BACKGROUND OF THE INVENTION

### Field of the Invention

The invention relates to a writing, marking and/or drawing liquid for capillary systems, especially for applicator implements having a capillary system, and to an applicator implement in which a writing, marking and/or drawing liquid of that kind is used.

Pigmented writing, marking and/or drawing liquids or pigmented liquid inks, have been known for many years for artist applications. They are frequently formulated with polymeric dispersions based on acrylate or on polyurethane as a binder, and with wetting agents too. Such writing, marking and/or drawing liquids are applied by way of so-called valve systems or capillary systems to absorbent substrates, preferably to paper or Bristol board. After the writing, marking and/or drawing liquid has undergone initial drying on the substrate, the applied colors possess a permanence toward water or at most a partial water solubility. In other words, after contact with water, the applied colors applied with the writing, decorating or drawing tip can still be seen and have not fully dissolved. The reason for that is that the pigments migrate together with the binder into the absorbent substrate and hence are difficult to dissolve out again. For many artistic applications, that effect is desirable. Among amateur or professional artists, however, another known form of application is that of watercolor techniques. For those applications there are watercolor paints available in the form of blocks. The watercolor paints are therefore typically applied by brush.

The application of watercolor paints through capillary systems, and especially through applicator implements with capillary systems, has been barely possible to date because of the typically high viscosities >50 cP (Brookfield, 20° C., cone-plate CPE-40) of watercolor paints. Such high-viscosity writing, marking and/or drawing liquids can usually be applied by using applicator implements or writing, marking or drawing implements which have a so-called valve system. With those implements, the writing, marking and/or drawing liquid is introduced as a free-flowing liquid into a reservoir within the shaft, and the liquid is delivered through a writing, marking or drawing tip, preferably made of polyester fibers or acrylic fibers or else made of sintered polyolefins. There is a valve provided between the tip and the reservoir for the regulated delivery of liquid. It is common for one or more mixing balls to be used in the reservoir in order to homogenize the writing, marking and/or drawing liquid through shaking of the applicator implement before the writing, marking and/or drawing liquid is applied.

In order to ensure sufficient application, liquids that are used in capillary systems must possess very low viscosities of less than 50 mPas, but preferably less than 20 mPas (Brookfield, 20° C., cone-plate CPE-40). Applicator implements in which such writing, marking and/or drawing liquids are used include a shaft, typically a plastics or metal housing, onto which a closure cap is pushed when the implement is not in use. The inside of the shaft accommodates a reservoir for the writing, marking and/or drawing liquid, made from a capillary material, such as from polyester fibers or polyolefin fibers, for example, and the reservoir is in fluid communication with an applicator element or a writing, marking or drawing tip, made from a likewise capillary material, such as a fiber tip or sintered tip, for example, so that the writing, marking and/or drawing liquid can be transported from the reservoir to the tip of the applicator element by virtue of adhesion forces and/or the capillary effect.

### SUMMARY OF THE INVENTION

It is accordingly an object of the invention to provide a writing, marking and/or drawing liquid for capillary systems, more particularly for applicator implements having capillary systems, which overcomes the hereinafore-mentioned disadvantages of the heretofore-known liquids of this general type. A further object of the invention is to provide an applicator implement, particularly an applicator implement having a capillary system, in which the writing, marking and/or drawing liquid is used.

With the foregoing and other objects in view there is provided, in accordance with the invention, a writing, marking and/or drawing liquid, more particularly an aqueous, pigmented and/or water-blendable writing, marking and/or drawing liquid, for capillary systems, more particularly for applicator implements having a capillary system. The writing, marking and/or drawing liquid has a viscosity of less than 40 mPas, more particularly less than 10 mPas (Brookfield, 20° C., cone-plate CPE-40), and includes at least one aqueous pigment preparation, at least one binder, at least one base, and at least one dispersing wetting agent, in which the dispersing wetting agent includes an aqueous solution of a modified polymer having groups with pigment affinity.

The writing, marking and/or drawing liquid is therefore a water-based liquid ink which includes pigments and has applied lines of color which are water-blendable—that is, after application and initial drying, they can be further treated by contact with water, using a moist brush or sponge, for example. As a result, it is possible to subsequently still undertake corrections to the applied paint and to spread it in the manner common with watercolor techniques, and to apply the corresponding techniques, such as washing or glazing. The capacity to do this is attributable to the improved migration behavior of the application liquid—that is, the pigment particles do not penetrate, or penetrate to less of an extent, into the decorating or drawing substrate, instead remaining adhering to the paper surface to an increased extent. Upon subsequent treatment, using a wet brush, for example, these particles can then be spread over the decorating or drawing substrate in order to achieve paint effects.

A dispersing wetting agent used in accordance with the invention, or an aqueous solution of this kind, of a modified polymer having groups with pigment affinity, is available, for example, under the tradename Tego Dispers 750W¹⁾. When specifically a dispersing wetting agent of this kind is used, there is hardly any sedimentation of the pigments to be seen, and the writing, marking and/or drawing liquid exhibits very good stability in storage. As a result, it can be used over a relatively long time in applicator implements featuring a capillary system, without any disruptive deposits occurring within the capillary system that might block the capillary channels.

The pigments are already in dispersed form in the aqueous pigment preparation, and they can be used directly for producing the writing, marking and/or drawing liquid. Aqueous pigment preparations that are used are pigment preparations sold, for example, under the tradenames Hostatint²⁾, Colanyl³⁾, Cosmenyl⁴⁾, Hostafine⁵⁾, Heucosperse⁶⁾ or the Levanyl⁷⁾ group.

Application by way of capillary systems is possible as a result of the low viscosity of <40 mPas, preferably even <10 mPas, of the writing, marking and/or drawing liquid.

The pigment preparation is preferably present in a concentration of 1 to 30 wt %, more particularly in a concentration of 1 to 25 wt %, in the writing, marking and/or drawing liquid. The pigment preparation in this case has a solids content in particular of between 30 and 60 wt %. With such a fraction of pigments in the writing, marking and/or drawing liquid, they can be distributed with sufficient homogeneity within the writing, marking and/or drawing liquid, and the writing, marking and/or drawing liquid displays good storage stability.

Within the pigment preparation there may be organic pigments, e.g., phthalocyanine or azo pigments and/or inorganic pigments, e.g., titanium dioxide or carbon black. In this case, in particular, organic pigments exhibit less sedimentation tendency within the writing, marking and/or drawing liquid, and so the use of organic pigments has emerged as being particularly advantageous in terms of the storage stability.

The pigments being used must be relatively small so that the capillary channels do not become blocked. Typically, therefore, pigments having a particle size ≤6 μm at D90 are suitable.

According to one preferred embodiment, the binder is a water-soluble resin and/or a polymeric dispersion from the group of modified, low molecular mass maleate resins and/or a polymeric dispersion from the group of styrene-acrylic resins and/or a saturated polyester resin.

An example of a binder which is used is a modified, oxidation-stable maleate resin having the following properties:

Melting point (Kofler hot stage, 6 min): 135±10° C.
Viscosity (efflux time 60% ethanol/20° C.;

### 4 DIN 53211): 75-125 s

Acid number (DIN ISO EN 2114): 160-200 mg KOH/g
Color number (Gardner Color Standard;
50% ethanol ASTM D 1544): max. 10
Density (as-supplied for 20° C.): about 1.1 g/cm³
Hydroxyl number (DIN 53240): about 140 mg KOH/g

A maleate resin of this kind is available for example under the tradename ERKAMAR 4170⁸⁾.

A further example of a binder which is used is a saturated polyester resin having the following specification:

Melting point (Kofler hot stage, 6 min): 70±5° C.
Viscosity (efflux time 60% ethanol/20° C.;

### 4 DIN 53211): 50-80 s

Acid number (DIN ISO EN 2114): 0-100 mg KOH/g
Color number (iodine color number;
50% ethanol DIN 6162): max. 2 mgl/100 ml
Density (as-supplied for 20° C.): about 1.25 g/cm³

A polyester resin of this kind is available for example under the tradename ROKRAPOL 7095⁹⁾.

Examples of polymeric dispersions from the group of the styrene-acrylic resins that are used as binders are available, for example, under the tradenames Joncryl HPD 496 MEA¹⁰⁾ and Joncryl HPD 396 MEA¹¹⁾, and have the following characteristics:

### Joncryl HPD 496 MEA:

Brookfield viscosity (25° C.): 700 mPas

pH: 8.5

Acid number (solid): 178

Density (25° C.): 1.07 g/cm³

Glass transition temperature T_{g} (DSC) 58° C.

### Joncryl HPD 396 MEA:

Brookfield viscosity (25° C.): 500 mPas

pH: 8.3

Acid number (solid): 185

Density (25° C.): 1.07 g/cm³

Glass transition temperature T_{g} (DSC) 91° C.

It has proven advantageous, furthermore, if the binder is present in a concentration of 1 to 30 wt %, particularly in a concentration of 2 to 25 wt %, in the writing, marking and/or drawing liquid. At these specific concentrations there is an improved migration behavior apparent on the part of the writing, marking and/or drawing liquid.

Furthermore, the writing, marking and/or drawing liquid is admixed with at least one base. The base being used preferably includes amines, more preferably monoethanolamine and/or triethanolamine.

In one advantageous embodiment, the base is present in a concentration of 0.5 to 20.0 wt %, more particularly in a concentration of 0.5 to 15.0 wt %. If the base is added with such a fraction to the writing, marking and/or drawing liquid, the pH can be reliably stabilized in the neutral to slightly alkaline range, thereby preventing or reducing precipitation and/or sedimentation of the pigments. Moreover, the base ensures that the writing, marking and/or drawing liquid or watercolor ink that is applied to the paper, especially watercolor paper, is still water-paintable even after a number of days.

There is an advantageous fraction of the dispersing wetting agent in the writing, marking and/or drawing liquid when that agent is present in a concentration of 0.2 to 10.0 wt %, more particularly in a concentration of 0.2 to 4.0 wt %.

In the case of a further advantageous embodiment, moreover, there is at least one sugar and/or sugar alcohol present in the writing, marking and/or drawing liquid. The sugar or sugar alcohol ensures that on the watercolor paper the color pigments and the binder accumulate to an increased extent on the sugar molecules and less frequently on the paper fibers. Furthermore, since sugar derivatives have very good water solubility, they improve the water-blendability. Fructose, glucose, mannose, invert sugar, sucrose, sorbitol, xylitol and/or mannitol are employed in particular in this context. The use of a single sugar or sugar alcohol is equally conceivable as the use of two or more sugars or sugar alcohols in combination.

In the case of a preferred use concentration of a sugar or sugar alcohol or of a mixture of sugars and/or sugar alcohols, the fraction thereof in the writing, marking and/or drawing liquid is 0.5 to 12 wt %.

It has likewise emerged as advantageous to add at least one preservative as an additive, which is present more particularly in a concentration of not more than 1.5 wt % in the writing, marking and/or drawing liquid. Preservatives which are usefully used are one or more selected from formaldehyde donors, phenoxyethanol, parabens, and isothiazolinones.

One suitable preservative, a formaldehyde donor, is available for example under the tradename ACTICIDE SR 7034¹²⁾. The known preservative is a biocide based on 1,6-dihydroxy-2,5-dioxahexane and tetramethylolacetylenediurea, where 1,6-dihydroxy-2,5-dioxahexane undergoes hydrolysis under environmental conditions, to form formaldehyde and ethylene glycol. Another suitable preservative is available for example under the tradename ACTIC IDE LT2¹³⁾. The preservative is an isothiazolinone-based biocide, including 2-bromo-2-nitropropane-1,3-diol and 2-octyl-2H-isothiazol-3-one.

The remaining part of the composition of the writing, marking and/or drawing liquid is accounted for by water, with water being present more particularly in a concentration of 40 to 85 wt %, very preferably in a concentration of 40 to 80 wt %.

With the objects of the invention in view, there is concomitantly provided an applicator implement, more particularly an applicator implement having a capillary system in which the writing, marking and/or drawing liquid is used. For this purpose, the applicator implement, more particularly a writing, marking or drawing implement, includes a writing, marking or drawing tip made of a capillary material, and a reservoir made of a capillary material and containing a writing, marking and/or drawing liquid having the properties described above.

Other features which are considered as characteristic for the invention are set forth in the appended claims.

Although the invention is illustrated and described herein as embodied in a writing, marking, and/or drawing liquid for capillary systems, especially for applicator implements having a capillary system, and an applicator implement, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying examples.

### BRIEF DESCRIPTION OF THE DRAWING

The FIGURE of the drawing is a longitudinal-sectional view of a capillary applicator implement.

### DETAILED DESCRIPTION OF THE INVENTION

Referring now in detail to the single FIGURE of the drawing, there is seen an applicator implement which is substantially pen-shaped and has a shaft 1 in which a reservoir 2 made of a capillary material, or a fiber reservoir of low density, such as a polyester fiber reservoir, for example, is disposed. The front end of the pen carries a writing tip 3 made of a capillary material, or a fiber tip, which at its rear end is in communication with and/or projects into the fiber reservoir 2.

The manufacture of the writing, marking and/or drawing liquid takes place predominantly in mixing tanks, in which the constituents of the writing, marking and/or drawing liquid are added. In this case, all the while, stirring tools provide for intensive commixing and sufficiently uniform distribution. The resultant writing, marking and/or drawing liquid is subsequently introduced into the capillary-material reservoir 2 of the above-described writing implement.

The tests were carried out by using the applicator implement to apply the writing, marking and/or drawing liquid onto various substrates, including watercolor paper and Bristol board. After a short initial drying time of at least 1 minute, the drawn line produced was treated by using a further applicator implement, in the present case a wet brush. The drawn line was subsequently evaluated in relation in particular to its water-blendability.

Set out below are five example formulations of writing, marking and/or drawing liquids. The values in the example formulations in percent by weight are based in each case on the total mass of the writing, marking and/or drawing liquid.

### Example 1

Example formulation of a black, pigmented, water-blendable writing, marking and/or drawing liquid having a viscosity of 4.0 mPas (Brookfield, 20° C., cone-plate CPE-40) and a pH of 8.2:

| | | |
|---|---|---|
| Hostatint Black GR 500 ²⁾ | 16.5 | wt % |
| Erkamar 4170 ⁸⁾ | 10.0 | wt % |
| Monoethanolamine | 2.9 | wt % |
| Tego Dispers 750 W ¹⁾ | 2.0 | wt % |
| Sorbitol | 0.8 | wt % |
| Acticide SR 7034 ¹²⁾ | 0.5 | wt % |
| Acticide LT2 ¹³⁾ | 0.3 | wt % |
| Water, demineralized | 67.0 | wt % |

In the manufacture of the writing, marking and/or drawing liquid according to example 1, the solid resin Erkamar 4170 is converted into a water-soluble form using monoethanolamine in an aqueous medium, with gentle heating. A writing, marking and/or drawing liquid having a composition corresponding to example 1 has a low fraction of sugar alcohol and a high fraction of aqueous pigment preparation. It is possible as a result to generate particularly intensely colored lines, and to do so in particular after use of watercolor techniques as well.

### Example 2

Example formulation of a yellow, pigmented, water-blendable marking liquid having a viscosity of 3.5 mPas (Brookfield, 20° C., cone-plate CPE-40) and a pH of 8.8:

| | | |
|---|---|---|
| Colanyl Yellow 5 GX 500 ³⁾ | 16.5 | wt % |
| Rokrapol 7095 ⁹⁾ | 10.0 | wt % |
| Monoethanolamine | 1.6 | wt % |
| Triethanolamine | 1.6 | wt % |
| Tego Dispers 750 W ¹⁾ | 0.5 | wt % |
| Glucose | 1.5 | wt % |
| Acticide SR 7034 ¹²⁾ | 0.8 | wt % |
| Water, demineralized | 67.5 | wt % |

In this case again, the solid resin Rokrapol 7095, during the manufacture of the writing, marking and/or drawing liquid, is converted into a water-soluble form using monoethanolamine in an aqueous medium, with gentle heating. A writing, marking and/or drawing liquid having a composition corresponding to example 2 has the lowest dispersing wetting agent content; nevertheless, it is possible to achieve sufficient distribution and stabilization of the pigments and an acceptable storage stability. The addition of triethanolamine brings about an improvement in particular in the long-term water-paintability.

### Example 3

Example formulation of a red, pigmented, water-blendable marking liquid having a viscosity of 5.5 mPas (Brookfield, 20° C., cone-plate CPE-40) and a pH of 8.3:

| | | |
|---|---|---|
| Hostafine Red HF3S ⁵⁾ | 10.0 | wt % |
| Hostafine Magenta E ⁵⁾ | 5.0 | wt % |
| Joncryl HPD 496 MEA ¹⁰⁾ | 16.0 | wt % |
| Triethanolamine | 1.0 | wt % |
| Tego Dispers 750 W ¹⁾ | 1.0 | wt % |
| Sucrose | 10.0 | wt % |
| Acticide SR 7034 ¹²⁾ | 0.5 | wt % |
| Acticide LT2 ¹³⁾ | 0.3 | wt % |
| Water, demineralized | 56.2 | wt % |

The binder used in the present case is a 35% solution of resin (Joncryl HPD 496 MEA¹⁰⁾), and so the binder content is only 5.6% solids. A writing, marking and/or drawing liquid having a composition corresponding to example 3 also has an increased sugar fraction relative to the preceding examples. The composition exhibits good storage stability and water-blendability.

### Example 4

Example formulation of a blue, pigmented, water-blendable marking liquid having a viscosity of 3.9 mPas (Brookfield, 20° C., cone-plate CPE-40) and a pH of 8.9:

| | | |
|---|---|---|
| Hostafine Blue B2G ⁵⁾ | 3.8 | wt % |
| Hostafine Magenta E ⁵⁾ | 3.7 | wt % |
| Joncryl HPD 496 MEA ¹⁰⁾ | 16.0 | wt % |
| Monoethanolamine | 3.0 | wt % |
| Tego Dispers 750 W ¹⁾ | 2.0 | wt % |
| Fructose | 6.0 | wt % |
| Acticide LT2 ¹³⁾ | 0.8 | wt % |
| Water, demineralized | 64.7 | wt % |

A writing, marking and/or drawing liquid having a composition corresponding to example 4 contains a comparatively low fraction of pigments, but continues to exhibit good water-blendability and also good storage stability.

### Example 5

Example formulation of a violet, pigmented, water-blendable marking liquid having a viscosity of 5.5 mPas (Brookfield, 20° C., cone-plate CPE-40) and a pH of 7.8:

| | | |
|---|---|---|
| Colanyl Violet RL 500 ³⁾ | 7.9 | wt % |
| Joncryl HPD 396 MEA ¹¹⁾ | 20.0 | wt % |
| Monoethanolamine | 0.5 | wt % |
| Tego Dispers 750 W ¹⁾ | 2.0 | wt % |
| Glucose | 10.0 | wt % |
| Acticide SR 7034 ¹²⁾ | 0.8 | wt % |
| Water, demineralized | 58.8 | wt % |

A writing, marking and/or drawing liquid having a composition corresponding to example 5 has by comparison the smallest fraction of a base, in the present case, monoethanolamine, which, nevertheless, is sufficient to establish a slightly alkaline pH so as to stabilize the liquid ink. Furthermore, the comparatively high sugar fraction in combination with the binder employed, a 35% solution of resin with a binder content of about 6.4% solids, ensures good water-blendability.

### MANUFACTURERS

1) Evonik Industries AG, Goldschmidtstr. 100, 45127 Essen
2), 3), 4), 5) Clariant AG, Industriepark Höchst, 65926 Frankfurt
6) Heubach GmbH, Heubachstraße 7, 38685 Langelsheim
7) Lanxess AG, Kennedyplatz 1, 50569 Cologne
8), 9) Robert Kraemer GmbH & Co. KG, Zum roten Hahn 9, 26180 Rastede
10), 11) BASF AG, BASF BV Resins and Additives PO. Box 390, 844AJ Heerenveen, Netherlands
12), 13) Thor GmbH, Landwehrstraße 1, 67346 Speyer, Germany

1. A writing, marking and/or drawing liquid or an aqueous, pigmented and/or water-blendable writing, marking and/or drawing liquid, for capillary systems or for applicator implements having a capillary system, the liquid comprising:
a viscosity of less than 40 mPas (Brookfield, 20° C., cone-plate CPE-40);
an aqueous pigment preparation;
a binder;
a base; and
a dispersing wetting agent including an aqueous solution of a modified polymer having groups with pigment affinity.

2. The writing, marking and/or drawing liquid according to claim 1, wherein said viscosity is less than 10 mPas (Brookfield, 20° C., cone-plate CPE-40).

3. The writing, marking and/or drawing liquid according to claim 1, wherein said pigment preparation is present in a concentration of 1 to 30 wt %.

4. The writing, marking and/or drawing liquid according to claim 3, wherein said pigment preparation is present in a concentration of 1 to 25 wt %.

5. The writing, marking and/or drawing liquid according to claim 1, wherein said pigment preparation has a solids content of between 30 and 60 wt %.

6. The writing, marking and/or drawing liquid according to claim 1, wherein said pigment preparation includes at least one of organic or inorganic pigments.

7. The writing, marking and/or drawing liquid according to claim 1, wherein said binder is at least one of a water-soluble resin or a polymeric dispersion selected from at least one of the group of modified, low molecular mass maleate resins or a polymeric dispersion selected from the group of styrene-acrylic resins or a saturated polyester resin.

8. The writing, marking and/or drawing liquid according to claim 1, wherein said binder is present in a concentration of 1 to 30 wt %.

9. The writing, marking and/or drawing liquid according to claim 8, wherein said binder is present in a concentration of 2 to 25 wt %.

10. The writing, marking and/or drawing liquid according to claim 1, wherein said base includes an amine or at least one of monoethanolamine or triethanolamine.

11. The writing, marking and/or drawing liquid according to claim 1, wherein said base is present in a concentration of 0.5 to 20.0 wt %.

12. The writing, marking and/or drawing liquid according to claim 11, wherein said base is present in a concentration of 0.5 to 15.0 wt %.

13. The writing, marking and/or drawing liquid according to claim 1, wherein said dispersing wetting agent is present in a concentration of 0.2 to 10.0 wt %.

14. The writing, marking and/or drawing liquid according to claim 13, wherein said dispersing wetting agent is present in a concentration of 0.2 to 4.0 wt %.

15. The writing, marking and/or drawing liquid according to claim 1, which further comprises at least one of a sugar or sugar alcohol.

16. The writing, marking and/or drawing liquid according to claim 15, wherein said sugar or sugar alcohol is at least one of fructose, glucose, mannose, invert sugar, sucrose, sorbitol, xylitol or mannitol.

17. The writing, marking and/or drawing liquid according to claim 15, wherein said sugar or sugar alcohol is present in a concentration of 0.5 to 12 wt %.

18. The writing, marking and/or drawing liquid according to claim 1, which further comprises a preservative.

19. The writing, marking and/or drawing liquid according to claim 18, wherein said preservative is present in a concentration of not more than 1.5 wt %.

20. An applicator implement or writing, marking or drawing implement, comprising:
a writing, marking or drawing tip formed of a capillary material;
a reservoir formed of a capillary material; and
a liquid according to claim 1 for at least one of writing, marking or drawing, said liquid being disposed in said reservoir.
